(19) United States
(12) Patent Application Publication
(10) Pub. No.: US 2004/0156373 A1
(43) Pub. Date: Aug. 12, 2004

(54) Apparatus and method for converting communication protocol

(76) Inventors: Sam Chul Ha, Kyongsangnam-do (KR); Seung Myun Baek, Kyongsangnam-do (KR); Koon Seok Lee, Kyongsangnam-do (KR); Jeong Hyun Lim, Kyongsangnam-do (KR); Hwan Jong Choi, Kyongsangnam-do (KR); Ja In Koo, Kyongsangnam-do (KR); Dae Woong Kim, Kyongsangnam-do (KR); Sung Hwan Kang, Kyongsangnam-do (KR)

Correspondence Address: MCKENNA LONG & ALDRIDGE LLP, 1900 K STREET, NW, WASHINGTON, DC, 20006, US

(21) Appl. No.: 10/481,817

(22) PCT Filed: Apr. 9, 2002
(86) PCT No.: PCT/KR02/00635

(30) Foreign Application Priority Data
Jun. 26, 2001 (KR) 2001/36614

(51) Int. Cl. H04L 12/28; H04L 12/56

(52) U.S. Cl. 370/401; 370/466

(57) ABSTRACT

An apparatus and method for converting communication protocol is disclosed, which is enable to communicate among apparatuses having different communication protocols by converting the different communication protocols into a protocol corresponding to one another. The apparatus includes a plurality of apparatuses having different communication protocols communicated in a bus line, and a converting apparatus connected to the plurality of apparatus for converting data input/output from an apparatus of a certain communication protocol by downloading communication protocol by Internet, or by mounting a card for converting communication protocol.

### TECHNICAL FIELD

The present invention relates to a communication between appliances, and more particular, to an apparatus and a method for converting a communication protocol, which is able to convert different communication protocols of two appliances to communication protocols of the same kind.

### BACKGROUND ART

Normally, communicationable appliances have a built-in central processing unit (CPU) and a universal asynchronous receiving/transmitting port to communicate with other appliances, and a typically used communication method among the appliances is a serial communication using RS-232C.

In addition, a special kind of protocol for communication among peripheral appliances at home is under development. More specifically, this protocol should be capable of integrating a number of different signals used in home equipments to one signal and controlling the signal for communication among different appliances.

Currently available protocols include CEBus of the U.S.A., Echonet of Japan, and LnCP of Korea.

However, because a communication protocol between Internet products has not been unified yet, a number of different data associations are established, respectively.

As a result thereof, each appliance uses a different communication protocol from each other, and communication speed between appliances also varies. Although establishing a network between different appliances is in progress, controlling the entire network uniformly is still difficult because the network between each appliance is yet impossible in reality.

Other drawbacks of setting up a communication protocol separately are that it requires a large amount of time to do the task, and the setup itself is very inconvenient because a communication protocol should be set for every appliance.

### DISCLOSURE OF THE INVENTION

To solve the above-described problems, it is, therefore, an object of the present invention to provide an apparatus and a method for converting a communication protocol, which enables appliances having different communication protocols to have communication with each other by converting the different communication protocol into a communication protocol of the same kind.

Another object of the present invention is to provide an apparatus and a method for converting a communication protocol, which can be easily applied to a newly upgraded communication protocol or to a newly developed communication protocol. To achieve the above objects, there is provided an apparatus for converting a communication protocol, which includes a plurality of appliances for communicating with one another through a single bus line by using different communication protocols; and a converter connected to the plural appliances, respectively, for converting data that is inputted/outputted from the appliances to a specific communication protocol by downloading a communication protocol through Internet or by mounting a communication protocol converting card.

Preferably, the converter includes: a communication block for downloading a large number of communication protocols over Internet and for mounting a particular kind of communication converting card; a displaying block for displaying the large number of communication protocols the communication block downloaded or mounted on a screen to enable a user to select and convert the communication protocols more easily; and a converting block for converting data that is inputted externally to a communication protocol format selected by the user and for outputting the converted data.

Moreover, the communication block includes EEPROM or flash memory.

Another aspect of the present invention provides a method for converting a communication protocol, the method comprising the steps of: connecting an appliance with a defined initial default protocol to a network; deciding whether the appliance connected to the network has a specific communication protocol; if the appliance does not have a specific communication protocol, setting up the specific communication protocol by downloading the corresponding protocol through Internet and saving the same into the appliance, or by mounting a specific communication protocol converting card; and if the appliance has a specific communication protocol or if the specific communication protocol is set up in the appliance through the setting step, defining a corresponding communication to a default protocol according as the user selected.

Preferably, the defining step further includes steps of: displaying a plurality of communication protocols that are set up in the appliance on a screen; selecting a specific communication protocol among the displayed communication protocols; and defining the selected specific communication protocol to a default protocol of a corresponding apparatus.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram of an apparatus for converting a communication protocol in accordance with an embodiment of the present invention;

FIG. 2 is an enlarged view of the converting apparatus shown in FIG. 1;

FIG. 3 illustrates an apparatus for converting a communication protocol in accordance with another embodiment of the present invention; and

FIG. 4 is a flow chart representing a method for converting a communication protocol in accordance with the present invention.

### BEST MODE FOR CARRYING OUT THE INVENTION

A preferred embodiment of the present invention will now be described with reference to the accompanying drawings. In the following description, well-known functions or constructions are not described in detail since they would obscure the invention in unnecessary detail.

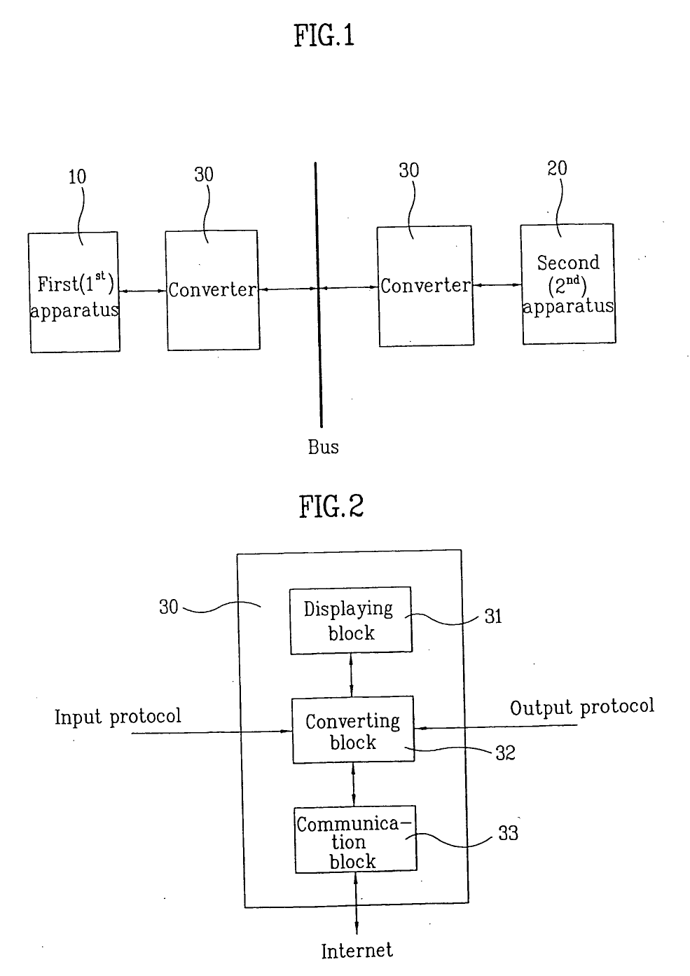

FIG. 1 is a schematic diagram of an apparatus for converting a communication protocol in accordance with an embodiment of the present invention.

Referring to FIG. 1, the apparatus for converting a communication protocol includes a first apparatus 10 and a second apparatus 20 for performing communication through a bus line by using different communication protocols from each other, and a converter 30 connected to the first and the second appliances 10 and 20, respectively, for downloading a communication protocol through Internet or for converting inputted/outputted data from a specific communication protocol to the appliances by mounting a communication protocol converting card.

The converter 30, as depicted in FIG. 2, includes a communication block 33 for downloading a plurality of communication protocols through Internet and saving the same in the apparatus, and for mounting a particular kind of communication converting card; a displaying block 31 for displaying the plural communication protocols the communication block 33 downloaded or mounted on a screen to enable a user to select and convert the communication protocols more easily; and a converting block 32 for converting data that is inputted externally to a communication protocol format selected by the user and for outputting the converted data.

Input/output port terminal of the converting block 32 includes PLC (Power Line Communication), serial communication (RS-232C), and RF terminal. The communication block includes EEPROM or flash memory, so it can save a version of the downloaded communication protocol and its present status.

As a first embodiment of FIG. 2 illustrates, the appliances 10 and 20, and the converter 30, are set up separately from each other, and the converter 30 is connected to an input port terminal of each apparatus.

Even though this might seem to complicate the network at home, considering that the number of communication protocols available is limited, it actually makes a more convenient network configuration at home because the communication protocols that are downloaded and saved in the converter can be connected to the apparatus for a later use, without downloading a relevant communication protocol whenever a new apparatus is added.

A second embodiment of the present invention does not connect the communication block 33, as in the first embodiment, to Internet, but forms a slot instead. Then, by plugging a protocol converting card from the outside in the apparatus through a serial interface, each apparatus can have a corresponding communication protocol.

In such manner, a user can save a lot of costs by using a low-price protocol converting card for a low-price converter, instead of mounting an expensive converter on every apparatus.

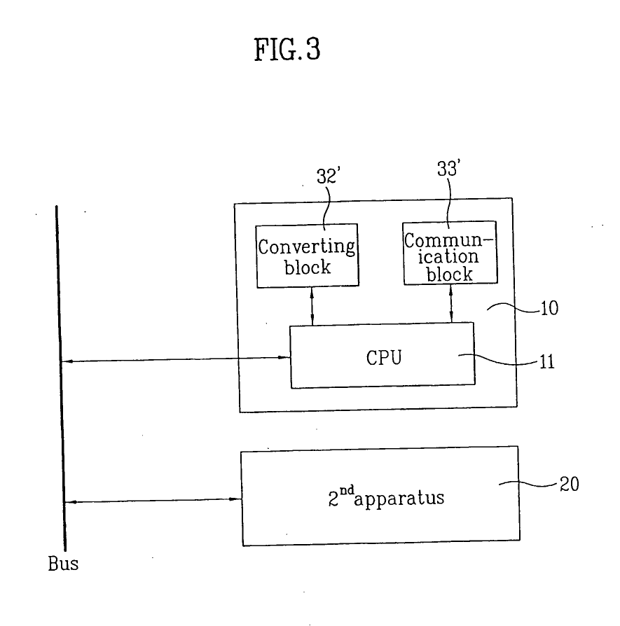

A third embodiment of FIG. 3 represents a configuration in which the converter according to the first embodiment and the second embodiment is mounted into each apparatus. Specifically speaking, when an apparatus is released from a manufacturing plant, it includes a converting block 32′ and a communication block 33′ therein.

As a result thereof, the network configuration at home can be simplified, and the user can easily configure the home network.

Explained next is the operation of the apparatus for converting a communication protocol in accordance with the first, the second, and the third embodiments of the present invention.

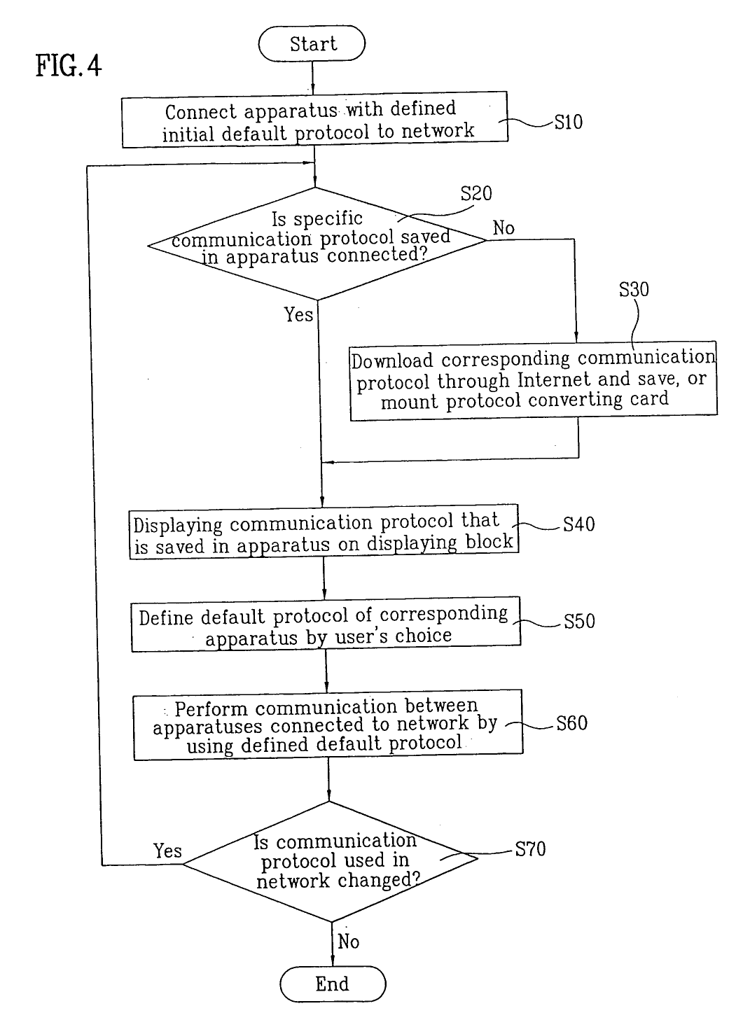

FIG. 4 is a flow chart representing a method for converting a communication protocol in accordance with the present invention.

Referring to FIG. 4, a user first purchases a new apparatus to add to the home network (S10). At this time, because every apparatus released from manufacturers already has a preset initial default protocol, the CPU checks the communication protocol that is preset in each apparatus.

Then, it is determined whether the same communication protocol that is currently being used for the home network is saved in the newly connected apparatus (S20).

If it turns out that the communication protocol that is currently being used for the network at home is not saved in the newly connected apparatus, in case of the first embodiment, the communicating block 33 inside of the converter downloads a wanted communication protocol through Internet by connecting to a web server where the communication protocol is saved, and saves the communication protocol. In case of the second embodiment, a user purchases a corresponding communication protocol converting card, and mounts it onto a slot that is formed in the converter.

Also, if it turns out that the corresponding communication protocol is already saved in the new apparatus, or the corresponding communication protocol is downloaded or the concerned card is mounted into the apparatus for saving the communication protocol, the saved communication protocol is displayed on the displaying block 31 inside of the converter (S40).

Afterwards, the user, using an input device, selects a corresponding communication protocol displayed on the displaying block 31, and the selected communication protocol is defined as a default protocol for the apparatus (S50).

As for the input device, an up/down/select key may be included in the converter 30, helping the user select or designate, or the input device can be mounted on the outside separately, so the user can select the kind of communication protocol he or she wants.

Once the communication protocol for a corresponding apparatus is selected and defined by the user, the communication among a plurality of apparatuses connected to the network can be performed using the defined communication protocol (S60).

Moreover, even when the network at home is changed, the communication protocol of every apparatus can be easily changed by repeating the above-described procedure, and connection to a new apparatus becomes much easier (S70).

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

### INDUSTRIAL APPLICABILITY

The apparatus and method for converting a communication protocol embodying the principles of the present invention has benefits as follows:

First of all, by adding a download function or a card function to the apparatus, the present invention can be easily applied to a newly upgraded communication protocol or to a newly developed communication protocol; and

Secondly, by easing conversion of a communication protocol among Internet products at home, a pass for the most efficient communication can be formed.

What is claimed is:

1. An apparatus for converting a communication protocol, the apparatus comprising:
a plurality of appliances for communicating with one another through a single bus line by using different communication protocol; and
a converter, connected to the plural appliances, respectively, for converting data that is inputted/outputted from the appliances with a specific communication protocol by downloading a communication protocol through Internet or by mounting a communication protocol converting card.

2. The apparatus as claimed in claim 1, wherein the converter further comprises:
a communication block for downloading a large number of communication protocols over Internet and for mounting a particular kind of communication converting card;
a displaying block for displaying the large number of communication protocols the communication block downloaded or mounted on a screen to enable a user to select and convert the communication protocols more easily; and
a converting block for converting data that is inputted externally to a communication protocol format selected by the user and for outputting the converted data.

3. The apparatus as claimed in claim 2, wherein a port terminal of the converting block for use input/output of data comprises one of PLC (Power Line Communication), serial communication (RS-232C), and RF terminal.

4. The apparatus as claimed in claim 2, wherein the communication block comprises EEPROM or flash memory.

5. A method for converting a communication protocol, the method comprising the steps of:
connecting an appliance with a defined initial default protocol to a network;
deciding whether the appliance connected to the network has a specific communication protocol;
if the appliance does not have a specific communication protocol, setting up the specific communication protocol by downloading the corresponding protocol through Internet and saving the same into the appliance, or by mounting a specific communication protocol converting card; and,
if the appliance has a specific communication protocol or if the specific communication protocol is set up in the appliance through the setting step, defining a corresponding communication to a default protocol according as the user selected.

6. The method as claimed in claim 5, wherein the defining step further comprises the sub-steps of:
displaying a plurality of communication protocols that are set up in the appliance on a screen;
selecting a specific communication protocol among the displayed communication protocols; and
defining the selected specific communication protocol to a default protocol of a corresponding appliance.

7. The method as claimed in claim 5, wherein the setting up step saves a version of the communication protocol to be set up and a present status of the communication protocol.
